(19) United States
(12) Patent Application Publication
(10) Pub. No.: US 2017/0218247 A1
(43) Pub. Date: Aug. 3, 2017

(54) THERMOSETTING COMPOSITION FOR USE AS LOST CIRCULATION MATERIAL

(71) Applicant: Dow Global Technologies LLC, Midland, MI (US)

(72) Inventors: Mark F. SONNENSCHEIN, Midland, MI (US); Michael K. POINDEXTER, Sugar Land, TX (US); Robert P. SCHLEMMER, Houston, TX (US); Justin M. VIRGILI, Oakland, CA (US); Benjamin L. WENDT, Midland, MI (US)

(73) Assignee: Dow Global Technologies LLC, Midland, MI (US)

(21) Appl. No.: 15/328,554

(22) PCT Filed: Sep. 3, 2015
(86) PCT No.: PCT/US2015/048237

§ 371 Date: Jan. 24, 2017

Related U.S. Application Data
(60) Provisional application No. 62/051,477, filed on Sep. 17, 2014.

(51) Int. Cl. C09K 8/035; C04B 26/06; C08L 63/00; C09K 8/575; C09K 8/44; C09K 8/467; C09K 8/508; C09K 8/588; C04B 26/14; C08L 63/04

(52) U.S. Cl. CPC C09K 8/035; C04B 26/14; C04B 26/06; C08L 63/00; C08L 63/04; C09K 8/44; C09K 8/467; C09K 8/508; C09K 8/588; C09K 8/5751; C08L 2205/03

(57) ABSTRACT

The present invention relates to compositions and methods for reducing or preventing the loss of drilling fluids and other well servicing fluids into a subterranean formation during drilling or construction of boreholes in said formation. Specifically, this invention comprises a curable thermosetting composition comprising a polyfunctional (meth)acrylate, a polyfunctional (meth)acrylamide, or mixture thereof, one or more epoxy resin, and one or more (cyclo)aliphatic polyamine.

### FIELD OF THE INVENTION

The present invention relates to compositions and methods of use for reducing or preventing the loss of drilling fluids and other well servicing fluids into a subterranean formation during drilling or construction of boreholes in said formation. Specifically, this invention comprises a thermosetting composition for creating lost circulation material in-situ.

### BACKGROUND OF THE INVENTION

In the oil and gas industry, a common problem in drilling wells or boreholes in subterranean formations is loss of circulation of fluids (for example, drilling fluids—“muds”, completion fluids, or cements) to those formations during the drilling process of well construction. Such lost fluids typically go into fractures induced by excessive mud pressures, into pre-existing open fractures, and/or into large openings existing within the formation.

A large variety of materials have been used or proposed in attempts to cure lost circulation. Generally, such materials may be divided into five types or categories: fibrous materials, such as shredded automobile tires or sawdust; flaky materials, such as wood chips and mica flakes; granular materials, such as calcium carbonate as ground limestone or ground marble, and ground nutshells; slurries, whose strength increases with time after placement, such as hydraulic cement; and polymerizable compositions.

Polymerizable compositions comprise one or more monomer, typically, comprising optional components, such as for example fillers, which cure in situ downhole. Various polymerizable compositions are known and may comprise such polymerizable and/or polymeric materials as an epoxy resin, an organic siloxane, a phthalate resin, a (meth)acrylate resin, an isocyanate-based resin, a polyacrylamide, or the like. For examples see U.S. Pat. Nos. 3,181,611 and 7,696,133; and US Publication No. 2009/0221452 and 2010/0087566; and WO 2010/019535, each of which is incorporated by reference herein in their entirety.

Although many materials and compositions exist and have been proposed for preventing lost circulation, there continues to be a need for even more versatile and better compositions and methods for preventing loss of circulation.

### SUMMARY OF THE INVENTION

The present invention is a curable thermosetting composition useful as a drilling mud additive, said curable thermosetting composition comprising the reaction product of: (i) a polyfunctional (meth)acrylate, a polyfunctional (meth)acrylamide, or mixture thereof, preferably each polyfunctional (meth)acrylate or polyfunctional (meth)acrylamide independently has a molecular weight of from 200 to 10,000 g/mol, (ii) one or more epoxy resin, preferably having a viscosity equal to or less than 50,000, and (iii) one or more (cyclo)aliphatic polyamine, preferably having a viscosity equal to or less than 50,000 cP.

Another embodiment of the present invention is a method to introduce a drilling mud comprising a curable thermosetting composition into a wellbore through a drill string, wherein the curable thermosetting composition comprises the reaction product of: (i) a polyfunctional (meth)acrylate, a polyfunctional (meth)acrylamide, or mixture thereof, preferably each polyfunctional (meth)acrylate or polyfunctional (meth)acrylamide independently has a molecular weight of from 200 to 10,000 g/mol, (ii) one or more epoxy resin, preferably having a viscosity equal to or less than 50,000, and (iii) one or more (cyclo)aliphatic polyamine, preferably having a viscosity equal to or less than 50,000 cP.

In one embodiment of the present invention, in the curable thermosetting composition and/or method disclosed herein above, (i) the (meth)acryl polymer preferably comprises one or more monomeric sub unit of ethylene glycol diethylene glycol, 1,3 butane diol, 1,4 butane diol, trimethylolpropane, ditrimethylolpropane, bisphenol-A diglycidyl ether diacrylate, dipentaerythritol pentaacrylate, poly(ethylene oxide), or poly(propylene oxide), (ii) the epoxy resin preferably comprises one or more monomeric sub unit of phenol, diglycidyl ether of bisphenol-A, diglycidyl ether of bisphenol-F, diglycidyl ether of bisphenol-S, diglycidyl ether of dicyclopentadiene, 3,4-epoxycyclohexylmethyl, or diglycidyl ethers of cyclohexanedimethanol, and (iii) the (cyclo)aliphatic polyamine preferably is amino ethyl piperazine or isophorondiamine

In one embodiment of the present invention, the curable thermosetting composition disclosed herein above is useful as an additive for enhanced oil recovery (EOR); loss circulation material (LCM); wellbore (WB) strengthening treatments; soil stabilization; as a dust suppressant; as a water retainer; a soil conditioner; as a concrete or cement stabilizer; or as a sealer for any porous substrate.

### DETAILED DESCRIPTION OF THE EMBODIMENTS

A “polymer,” as used herein and as defined by F W Billmeyer, JR. in Textbook of Polymer Science, second edition, 1971, is a relatively large molecule made up of the reaction products of smaller chemical repeat units. Polymers may have structures that are linear, branched, star shaped, looped, hyperbranched, crosslinked, or a combination thereof; polymers may have a single type of repeat unit (“homopolymers”) or they may have more than one type of repeat unit (“copolymers”). Copolymers may have the various types of repeat units arranged randomly, in sequence, in blocks, in other arrangements, or in any mixture or combination thereof. Chemicals that react with each other to form the repeat units of a polymer are known herein as “monomers,” and a polymer is said herein to be made of, or comprise, “polymerized units” of the monomers that reacted to form the repeat units. The chemical reaction or reactions in which monomers react to become polymerized units of a polymer, whether a homopolymer or any type of copolymer, are known herein as “polymerizing” or “polymerization.”

A copolymer comprises two or more monomers, for example it may comprise two, three, four, five, six, or more monomers. However, if a copolymer is described as “consisting of” two monomers (for example monomers A and B), the copolymer is made up of only the two monomers (i.e., A and B). In other words, the phrase “a copolymer consisting of the polymerization product of monomers A and B” means that the copolymer is made up of only the monomeric subunits of A and B.

Alternatively, if a copolymer is described as consisting of three monomers selected from monomers A, B, C, D, E, and F, the copolymer is made up of any selection of only three monomers from the group of A, B, C, D, E, and F, for example A, B, and C; or A, C, and D; or A, C, and E; etc.

In all of the compositions herein the weight percentages will always total 100 percent. Thus, the percentages stated hereinbelow to describe the proportions of the various monomeric components in the polymer are all based on the total weight of the polymer, with the total being 100 percent.

As used herein, the prefix “(meth)acryl” means “methacryl or acryl”, for example (meth)acrylate means methacrylate or acrylate or (meth)acrylamide means methacrylamide or acrylamide. A (meth)acrylate and a (meth)acrylamide have the same basic structure with the exception that one is an ester (i.e., the (meth)acrylate) and one is an amide (i.e., is the (meth)acrylamide) is herein after referred to as (meth)acrylate/amide, for example, when referring to ethylene glycol (meth)acrylate and/or ethylene glycol (meth)acrylamide it may be referred to as ethylene glycol (meth)acrylate/amide.

As used herein “poly” as in polyfunctional means two or more.

The present invention is a curable thermosetting composition useful as a drilling well lost circulation material, said curable thermosetting composition comprises the reaction product of: (i) a poly(meth)acrylate, polyfunctional (meth)acrylamide, or mixture thereof, (ii) one or more epoxy resin, and (iii) one or more (cyclo)aliphatic amine.

Component (i) of the composition of the present invention is a polyfunctional (meth)acrylate, a polyfunctional (meth)acrylamide, or a mixture thereof. The nitrogen atom in a (meth)acrylamide may be substituted with one or two hydrogens, or one or two alkyl groups having from 1 to 6 carbon atoms, preferably 1 carbon (i.e., a methyl group), or one hydrogen and one alkyl group. If the nitrogen has two alkyl groups they may be the same or different, e.g., if they are the same, for example, it may be substituted with two methyl groups, alternatively, if they are different it may be substituted with, for example, a methyl group and an ethyl group.

Suitable polyfunctional (meth)acrylates and polyfunctional (meth)acrylamide include those based on 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, bisphenol A, hydrogenated bisphenol A, 1,1,1-trimethylolethane, 1,1,1-trimethylolpropane, glycerol, pentaerythritol, sorbitol, and mixtures of the aforementioned compounds.

Specific examples of polyfunctional (meth)acrylates/polyfunctional (meth)acrylamides (herein after referred to as (meth)acrylate/amide) include ethylene glycol di(meth)acrylate/amide, diethylene glycol di(meth)acrylate/amide, triethylene glycol di(meth)acrylate/amide, polyethylene glycol di(meth)acrylate/amide, polypropylene glycol di(meth)acrylate/amide, butylene glycol di(meth)acrylate/amide, neopentyl glycol di(meth)acrylate/amide, 1,4-butanediol di(meth)acrylate/amide, 1,6-hexanediol di(meth)acrylate/amide, pentaerythritol di(meth)acrylate/amide, pentaerythritol tri(meth)acrylate/amide, pentaerythritol tetra(meth)acrylate/amide, dipentaerythritol penta(meth)acrylate/amide, trimethylolpropane tri(meth)acrylate/amide, 2,2,5,5-tetrahydroxymethylcyclopentanone tetra(meth)acrylate/amide, and tetramethylolmethane tetra(meth)acrylate/amide. In addition to the above, bisphenol diglycidyl ether diacrylate/amide compounds obtained from a polyhydric phenol such as bisphenol A and glycidyl (meth)acrylate/amide and bisphenol di(meth)acrylate/amide compounds obtained from bisphenol and (meth)acrylic acid or (meth)acryl chloride, for example see U.S. Pat. No. 5,496671, which is incorporated by reference herein in its entirety.

In one embodiment, the polyfunctional (meth)acrylate/amide is a (meth)acrylate/amide end capped polyol. Exemplary polyols are polyoxyalkylenepolyols, also known as “polyether polyols”, polyester polyols, polycarbonate polyols and mixtures thereof. Most preferred polyols include diols, especially polyoxyethylenediols, polyoxypropylenediols or polyoxybutylenediols. Suitable polyether polyols, also known as polyoxyalkylenepolyols or oligoetherols are, for example, those which are polymerization products of ethylene oxide, 1,2-propylene oxide, 1,2- or 2,3-butylene oxide, oxetane, tetrahydrofuran or mixtures thereof. Particularly suitable are polyoxyethylenepolyols and polyoxypropylenepolyols, for example, polyoxyethylenediols, polyoxypropylenediols, polyoxyethylenetriols and polyoxypropylenetriols.

Preferred polyfunctional (meth)acrylate/amides are based on ethylene glycol (EG), diethylene glycol (DEG), 1,3 butane diol (1,3-BDO), 1,4 butane diol (1,4-BDO), trimethylolpropane (TMP), ditrimethylolpropane (di-TMP acrylate available as SARTOMER™ SR 355 available from Arkema Group), bisphenol-A diglycidyl ether diacrylate/amide (acrylate available as SARTOMER CN-120Z) and its alkoxylates (e.g., SARTOMER SR 349), dipentaerythritol pentaacrylate/amide (acrylate available as SARTOMER SR 399), poly(ethylene oxide) having a molecular weight range of 200 to 10,000 g/mol, and poly(propylene oxide) having a molecular weight range of 200 to 10,000 g/mol. Mixtures of polyfunctional (meth)acrylate/amides may be utilized to suit application needs.

The polyfunctional (meth)acrylate and/or polyfunctional (meth)acrylamide (i), are independently present in an amount of from equal to or greater than 10 weight percent, preferably equal to or greater than 15, and more preferably equal to or greater than 20 weight percent based on the total weight of the reactants (i), (ii), and (iii). The polyfunctional (meth)acrylate and/or polyfunctional (meth)acrylamide (i), are independently present in an amount of from equal to or less than 60 weight percent, preferably equal to or less than 50, and more preferably equal to or less than 40 weight percent based on the total weight of the reactants (i), (ii), and (iii).

Component (ii) of the composition of the present invention is an epoxy resin. Suitable epoxy resins according to the present invention have an average functionality greater than 1. As a result of the reactive groups, the compound can be reacted with suitable hardeners and thereby hardened. Epoxy resins hardenable according to the present invention are selected from epoxy resins of the bisphenol A type, epoxy resins of the bisphenol S type, epoxy resins of the bisphenol F type, epoxy resins of the phenol novolac type, epoxy resins of the cresol novolac type, epoxidized products of numerous dicyclopentadiene-modified phenol resins obtainable by the reaction of dicyclopentadiene with numerous phenols, epoxidized products of 2,2′,6,6′-tetramethylbiphenol, aromatic epoxy resins such as epoxy resins having a naphthalene basic framework and epoxy resins having a fluorene basic framework, aliphatic epoxy resins such as neopentyl glycol diglycidyl ethers and 1,6-hexanediol diglycidyl ethers, alicyclic epoxy resins such as 3,4-epoxycyclohexylmethyl-3,4-epoxycyclohexane carboxylate and bis(3,4-epoxycyclohexyl)adipate, and epoxy resins having a hetero ring, such as triglycidyl isocyanurate.

Particularly preferred epoxy resins are the reaction products of bisphenol A and epichlorohydrin, the reaction products of phenol and formaldehyde (novolac resins) and epichlorohydrin, glycidyl esters, and the reaction product of epichlorohydrin and p-aminophenol.

Further preferred epoxy resins that are commercially obtainable are, in particular, epichlorohydrin, glycidol, glycidyl methacrylate, diglycidyl ethers of bisphenol A (e.g. those obtainable under the commercial designations EPON™ 828, EPON 825, EPON 1004, EPON 1007, EPON 1002, EPON 1001, and EPON 1010 available from Hexion Specialty Chemicals Inc., DER™-331, DER-332, DER-334, DER-354, DER-732, and DER-736 available from The Dow Chemical Company, vinylcyclohexene dioxide, 3,4-epoxycyclohexylmethyl-3,4-epoxycyclohexene carboxylate, 3,4-epoxy-6-methylcyclohexylmethyl-3,4-epoxy-6-methylcyclohexene carboxylate, bis(3,4-epoxy-6-methylcyclohexylmethyl)adipate, bis(2,3-epoxycyclopentyl)ether, aliphatic epoxide modified with polypropylene glycol, dipentene dioxide, epoxidized polybutadiene (e.g., KRASOL™ products of Sartomer), silicone resins containing epoxide functionality, flame-retardant epoxy resins (e.g., DER-580, a brominated epoxy resin of the bisphenol type obtainable from The Dow Chemical Company), 1,4-butanediol diglycidyl ethers of a phenol/formaldehyde novolac (e.g., DEN-431 and DEN-438 of the The Dow Chemical Company), as well as resorcinol diglycidyl ethers (e.g., KOPOXITE™ of the Koppers Company Inc.), bis(3,4-epoxycyclohexyl)adipate, 2-(3,4-epoxycyclohexyl-5,5-spiro-3,4-epoxy)cyclohexanemetadioxane, vinylcyclohexene monoxide, 1,2-epoxyhexadecane, alkyl glycidyl ethers such as, for example, C₈ to C₁₀ alkyl glycidyl ethers (e.g., HELOXY™ Modifier 7 of Hexion Specialty Chemicals Inc.), C₁₂ to C₁₄ alkyl glycidyl ethers (e.g., HELOXY Modifier 8 of Hexion Specialty Chemicals Inc.), butyl glycidyl ethers (e.g., HELOXY Modifier 61 of Hexion Specialty Chemicals Inc.), cresyl glycidyl ethers (e.g., HELOXY Modifier 62 of Hexion Specialty Chemicals Inc.), p-tert-butylphenyl glycidyl ethers (e.g., HELOXY Modifier 65 of Hexion Specialty Chemicals Inc.), polyfunctional glycidyl ethers such as, for example, diglycidyl ethers of 1,4-butanediol (e.g., HELOXY Modifier 67 of Hexion Specialty Chemicals Inc.), diglycidyl ethers of neopentyl glycol (e.g., HELOXY Modifier 68 of Hexion Specialty Chemicals Inc.), diglycidyl ethers of cyclohexanedimethanol (e.g., HELOXY Modifier 107 of Hexion Specialty Chemicals Inc.), trimethylolethane triglycidyl ethers (e.g., HELOXY Modifier 44 of Hexion Specialty Chemicals Inc.), trimethylolpropane triglycidyl ethers (e.g., HELOXY Modifier 48 of Hexion Specialty Chemicals Inc.), polyglycidyl ethers of an aliphatic polyol (e.g., HELOXY Modifier 84 of Hexion Specialty Chemicals Inc.), polyglycol diepoxide (e.g., HELOXY Modifier 32 of Hexion Specialty Chemicals Inc.), bisphenol F epoxies (e.g., EPN™-1138″ or “GY™-281” available from Huntsman Int. LLC), 9,9-bis-4-(2,3-epoxypropoxy)phenylfluorenone (e.g., EPON 1079 of Hexion Specialty Chemicals Inc.).

Preferred epoxy resins include those based on Bisphenol-A diglycidyl ether, such as DER 331 and DER 383 (Dow Chemical), those based on phenol, such as DEN 438 (Dow Chemical), those based on diglycidyl ethers of Bisphenol-F, Bisphenol-S, or dicyclopentadiene, and cycloaliphatic epoxies, such as 3,4-epoxycyclohexylmethyl (SYNA™ Epoxy 21) or diglycidyl ethers of cyclohexanedimethanol (CHDM).

Mixtures of epoxy resins may be utilized to suit application needs.

Preferred epoxy resins are room temperature liquids with a viscosity equal to or less than 50,000 cP, preferably equal to or less than 20,000 cP, and most preferably equal to or less than 10,000 cP.

The epoxy resin (ii) is present in an amount of from equal to or greater than 20 weight percent, preferably equal to or greater than 30, and more preferably equal to or greater than 40 weight percent based on the total weight of the reactants (i), (ii), and (iii). The epoxy resin (ii) is present in an amount of from equal to or less than 80 weight percent, preferably equal to or less than 60, and more preferably equal to or less than 50 weight percent based on the total weight of the reactants (i), (ii), and (iii).

Component (iii) of the composition of the present invention is a (cyclo)aliphatic polyamine. The (cyclo)aliphatic polyamine according to the present invention is used to harden the reactive resins, as long as suitable reactivity exists, for example, the (meth)acryl-based resins, and/or the epoxy-based systems.

Useful (cyclo)aliphatic polyamines include those based on piperazine, such as amino ethyl piperazine, isophorondiamine (IPDA), and reductively aminated polyols, such as Huntsman's Jeffamine D230. Preferred amines are room temperature liquids with a viscosity equal to or less than 50,000 cP, preferably equal to or less than 20,000 cP, and most preferably equal to or less than 10,000 cP.

The (cyclo)aliphatic polyamine (iii) is present in an amount of from equal to or greater than 10 weight percent, preferably equal to or greater than 15, and more preferably equal to or greater than 20 weight percent based on the total weight of the reactants (i), (ii), and (iii). The (cyclo)aliphatic polyamine (iii) is present in an amount of from equal to or less than 40 weight percent, preferably equal to or less than 35, and more preferably equal to or less than 30 weight percent based on the total weight of the reactants (i), (ii), and (iii).

In one embodiment of the present invention, the (cyclo)aliphatic amine may be pre-reacted with multi-functional (meth)acrylates or (meth)acrylamides to form amine functionalized adducts or used as mixtures.

The formulations of the present invention may further comprise one or more additive commonly used in curable compositions for lost circulation materials, such as accelerants, suspending agents, treatment fluid ingredients, weighting agents, density materials, and lost circulation additives.

Accelerants known in the art can be added to the formulation. Suitable accelerants are (cyclo)aliphatic isocyanates and include both linear aliphatic isocyanates, for example hexamethylene diisocyanate (HDI), cycloaliphatic isocyanates, and isophorone diisocyanate (IPDI).

Suspending agents known in the art can be added to the formulation to support solids. The invention is not intended to be limited to any particular agents, however suitable suspending agents include, for example, organophilic clays, amine treated clays, oil soluble polymers, quaternary ammonium compounds, polyamide resins, polycarboxylic acids, and soaps.

The formulation may also contain other common treatment fluid ingredients such as fluid loss control additives, dyes, anti-foaming agents when necessary, and the like, employed in typical quantities, known to those skilled in the art. Of course, the addition of such other additives should be avoided if it will detrimentally affect the basic desired properties of the treatment fluid.

Weighting agents or density materials may be added to the formulation. Suitable materials include, for example, galena, hematite, magnetite, iron oxides, ilmenite, barite, siderite, celestite, dolomite, calcite (and all minerals of calcium carbonate), manganese oxides, magnesium oxide, zinc oxide, zirconium oxides, spinels and the like. The quantity of such material added, if any, depends upon the desired density of the chemical treatment composition. Typically, weight material is added to result in a drilling fluid density of up to about 9 pounds per gallon. The weighted material is preferably added up to 5 pounds per barrel and most preferably up to 700 pounds per barrel of resin blend.

Lost circulation additives may also be incorporated into the formulation. These materials are generally categorized as fibers, flakes, granules, and mixtures thereof. Specific examples include, but are not limited to, ground mica, mica flakes, silica slag, diatomaceous earth, hydrated borate, graded sand, diatomaceous earth, gilsonite, ground coal, charcoal, cellophane flakes or strips, cellulose fiber, expanded perlite, shredded paper or paper pulp, and the like, walnut or other nut hulls, cottonseed hulls or cottonseed bolls, sugar cane fibers or bagess, flax, straw, ground hemp, ground fir bark, ground redwood bark and fibers, and grape extraction residue, crystalline silicas, amorphous silicas, clays, calcium carbonate, and barite Any of these material may be used as chopped, ground or otherwise processed to different or specific sizes. Suitable amounts of additional solid agents for use in combination with the copolymer(s) and/or ionomer(s) would be apparent to those skilled in the art.

The curable thermosetting composition of the present invention may be used as an additive in drilling muds for applications including: an additive for enhanced oil recovery (EOR); as an additive for loss circulation material (LCM); an additive for wellbore (WB) strengthening treatments; an additive for soil stabilization; an additive as a dust suppressant; an additive as a water retainer or a soil conditioner; an additive as a concrete or cement stabilizer; an additive as a sealer for any porous substrate; and others.

Drilling fluids or muds typically include a base fluid (for example water based or natural or synthetic oil based). Aqueous fluid for water-based drilling fluids may, for example, be selected from fresh water, sea water, brine, water-soluble organic compounds, and mixtures of the above. Natural or synthetic oil to form an oil or synthetic-based fluid may, for example, be selected from diesel oil, mineral oil, mono-olefins, polyolefins, polydiorganosiloxanes, ester-based oils, ether based oils, and mixtures of the above.

Drilling fluids may further comprise weighting agents for example but not limited to galena, hematite, magnetite, iron oxides, ilmenite, barite, siderite, celestite, dolomite, calcite (and all minerals of calcium carbonate), manganese oxides, magnesium oxide, zinc oxide, zirconium oxides, spinels and the like, clays such as but not limited to bentonite, hectorite, and attpulgite clay, and various additives that serve specific functions, such as polymers, corrosion inhibitors, emulsifiers, and lubricants. Those having ordinary skill in the art will recognize that a number of different muds exist and limitations on the present invention is not intended by reference to particular types. During drilling, the mud is injected through the center of the drill string to the drill bit and exits in the annulus between the drill string and the wellbore, fulfilling, in this manner, the cooling and lubrication of the bit, stabilization of the wellbore, and transporting the drill cuttings to the surface.

In one embodiment of the present invention, the curable thermosetting composition disclosed herein may be used as an additive in drilling mud. The curable thermosetting composition contained in the drilling fluid may be deposited along the wellbore throughout the drilling process.

In one embodiment, the curable thermosetting composition of the present invention may be applied to the wellbore through a drill string, by an open-ended treatment if a large LCM (lost circulation material) is used, by a spot-and-hesitation squeeze, or by a bullhead-and-hesitation squeeze (particularly in a severe loss zone). Preferably the curable thermosetting composition will exhibit radial penetration away from the wellbore of 0.025 to 2 m. The curable thermosetting composition hardens in the pores or micro-fractures or fractures existing or formed within formation and bonds formation particles together to form a rock-resin composite. Depending on the wellbore issue, one or more application of the inventive formulation may be required.

After a zone is treated it can be pressure tested and drilling can be resumed. It may be appropriate at this point to use a higher or lower mud weight, as will be apparent to those skilled in the art.

In the use of the curable thermosetting composition of the present invention, the components (i.e., components (i), (ii), and (iii)) can be continuously mixed in an automated chemical metering and pumping system. Various components can be mixed in an enclosed, in-line mixing device prior to pumping into a well. In one embodiment, the pump used to inject the curable thermosetting composition into the well may be part of the drilling/workover rig. It is also within the scope of the invention that the pump used to inject the chemical mixture into the well may be a specialized high pressure pump, such as a cement pump or stimulation pump that is not an integral part of the drilling/workover rig.

The curable thermosetting composition of the present invention may be used together, as a cured or uncured component, with other additives known in the art to form oil-based, water-based, or synthetic oil-based drilling fluids; or they may be used with other well fluids such as cements, spacer fluids, completion fluids, and workover fluids. Examples of other additives include, for example, viscosifying agents, filtrate reducing agents, weighting agents, and cements. The curable or cured thermosetting composition is preferably used in the fluid at a concentration level between 2 ppb (pound per barrel) and 50 ppb. (Note 2 pound per barrel is approximately 5.7 g/L; 50 pound per barrel is approximately 143 g/L.)

The following examples will serve to illustrate the invention disclosed herein.

### EXAMPLES

The following reactants are used in Examples 1 to 5 and Comparative Example A.
TMPTA is trimethylolpropane triacrylate available from Sigma Aldrich,
PPG800-diAc is an 800 g/mol acrylate functionalized polypropylene glycol available from Sigma Aldrich,
PPG2000-diUA is a urethane acrylate (UA) comprised of 2,000 g/mol polypropylene glycol TDI-capped prepopolymer reacted with P2000,
D.E.R.™ 331 is a liquid epoxy resin comprising a diglycidyl ether of bisphenol A available from The Dow Chemical Company,
D.E.N.™ 438 is a diglycidyl ether of an epoxy novolac available from The Dow Chemical Company,
AEP: is amino ethyl piperazine available from Sigma Aldrich,
IPDA: is isophorondiamine available from Sigma Aldrich,
IPDI: is isophorondiisocyanate available from Sigma Aldrich,
AIBN: is azobisisobutyronitrile available from Sigma Aldrich, and
IPA: is isopropanol available from Fisher.

### Example 1

31.8 g D.E.R. 331, 16.8 g PPG800-diAc, and 2.1 g TMPTA are combined via a SPEEDMIXER™ available from Hauschild at 2500 rpm for 2 min. 15.0 g of AEP is added to the mixture and the entire mixture combined using the SPEEDMIXER at 2500 rpm for 0.5 min. The mixture is then poured into a 0.55″ diameter×3″ height disposable plastic syringe or an aluminum mold pre-coated with a silicone release agent to form a rectangular plaque (4″×5″× 1/16″). The castings are allowed to cure at room temperature overnight. Specimens for physical property evaluation are then prepared by using a saw to cut the cylindrical specimen to dimensions of 0.55″ diameter×1″ height or using a punch and compression device to prepare tensile specimens according to ASTM D638, Type 5.

Tensile properties and compressive strength are measured according to ASTM D638 and D695, respectively. Compressive strength is measured to a deformation of 50% or to rupture, depending on which occurs first. Results are reported in Table 1. Resistance to solvent uptake is measured by immersing a specimen (tensile bar end of approximately similar size) in the specified solvent (water, hexanes, xylenes) for 24 hr and comparing the initial and post-immersion specimen weight after wiping excess solvent. Results are reported in Table 2.

Cure kinetics are measured using a stress-controlled (1 Pa) ARES™ G2 rheometer using a cone)(2° and plate geometry (60 mm) or an ARES rheometer using a parallel plate geometry (25 mm). Viscosity is monitored as a function of time at constant temperature, strain rate, and frequency (1 Hz). Results are reported in Tables 3 to 5.

### Example 2

24.0 g D.E.R. 331, 12.9 g PPG800-diAc, and 1.5 g TMPTA are hand mixed. 15.0 g of IPDA is added to the mixture and the entire mixture combined using the SPEEDMIXER at 2500 rpm for 0.5 min. The mixture is then poured into a 0.55″ diameter×3″ height disposable plastic syringe or an aluminum mold pre-coated with a silicone release agent to form a rectangular plaque (4″×5″× 1/16″). The castings are allowed to cure at room temperature overnight. Specimens for physical property evaluation are then prepared by using a saw to cut a cylindrical specimen to dimensions of 0.55″ diameter×1″ height.

Tensile properties and compressive strength are measured according to ASTM D638 and D695, respectively. Compressive strength is measured to a deformation of 50% or to rupture, depending on which occurred first. Results are reported in Table 1. Resistance to solvent uptake is measured by immersing a specimen (tensile bar end of approximately similar size) in the specified solvent (water, hexanes, xylenes) for 24 hr and comparing the initial and post-immersion specimen weight after wiping excess solvent. Results are reported in Table 2.

Cure kinetics are measured using a stress-controlled (1 Pa) ARES G2 rheometer using a cone (2°) and plate geometry (60 mm) or an ARES rheometer using a parallel plate geometry (25 mm). Viscosity is monitored as a function of time at constant temperature, strain rate, and frequency (1 Hz). Results are reported in Tables 3 to 5.

### Example 3

27.9 g D.E.R. 331, 14.9 g PPG800-diAc, and 1.8 g TMPTA are hand mixed. 7.5 g of AEP and 7.5 g IPDA are added to the mixture and the entire mixture combined using the SPEEDMIXER at 2500 rpm for 0.5 min. The mixture is then poured into a 0.55″ diameter×3″ height disposable plastic syringe or an aluminum mold pre-coated with a silicone release agent to form a rectangular plaque (4″×5″× 1/16″). The castings are allowed to cure at room temperature overnight. Specimens for physical property evaluation are then prepared by using a saw to cut a cylindrical specimen to dimensions of 0.55″ diameter×1″ height.

Tensile properties and compressive strength are measured according to ASTM D638 and D695, respectively. Compressive strength is measured to a deformation of 50% or to rupture, depending on which occurred first. Results are reported in Table 1. Resistance to solvent uptake is measured by immersing a specimen (tensile bar end of approximately similar size) in the specified solvent (water, hexanes, xylenes) for 24 hr and comparing the initial and post-immersion specimen weight after wiping excess solvent. Results are reported in Table 2.

Cure kinetics are measured using a stress-controlled (1 Pa) ARES G2 rheometer using a cone (2°) and plate geometry (60 mm) or an ARES rheometer using a parallel plate geometry (25 mm). Viscosity is monitored as a function of time at constant temperature, strain rate, and frequency (1 Hz). Results are reported in Tables 3 to 5.

### Example 4

31.8 g D.E.R. 331, 12.6 g PPG800-diAc, and 2.1 g TMPTA are hand mixed. 15.0 g of AEP and 3.4 g IPDI are added to the mixture and the entire mixture combined using the SPEEDMIXER at 2500 rpm for 0.5 min. The mixture is then poured into a 0.55″ diameter×3″ height disposable plastic syringe or an aluminum mold pre-coated with a silicone release agent to form a rectangular plaque (4″×5″× 1/16″). The castings are allowed to cure at room temperature overnight. Specimens for physical property evaluation are then prepared by using a saw to cut a cylindrical specimen to dimensions of 0.55″ diameter×1″ height.

Tensile properties and compressive strength are measured according to ASTM D638 and D695, respectively. Compressive strength is measured to a deformation of 50% or to rupture, depending on which occurred first. Results are reported in Table 1. Resistance to solvent uptake is measured by immersing a specimen (tensile bar end of approximately similar size) in the specified solvent (water, hexanes, xylenes) for 24 hr and comparing the initial and post-immersion specimen weight after wiping excess solvent. Results are reported in Table 2.

Cure kinetics are measured using a stress-controlled (1 Pa) ARES G2 rheometer using a cone (2°) and plate geometry (60 mm) or an ARES rheometer using a parallel plate geometry (25 mm). Viscosity is monitored as a function of time at constant temperature, strain rate, and frequency (1 Hz). Results are reported in Tables 3 to 5.

### Example 5

30.1 g D.E.N. 438, 16.9 g PPG800-diAc, and 2.1 g TMPTA are hand mixed. 15.0 g of AEP is added to the mixture and the entire mixture combined using the SPEEDMIXER at 2500 rpm for 0.5 min. The mixture is then poured into a 0.55″ diameter×3″ height disposable plastic syringe or an aluminum mold pre-coated with a silicone release agent to form a rectangular plaque (4″×5″× 1/16″). The castings are allowed to cure at room temperature overnight. Specimens for physical property evaluation are then prepared by using a saw to cut the cylindrical specimen to dimensions of 0.55″ diameter×1″ height or using a punch and compression device to prepare tensile specimens according to ASTM D638, Type 5.

Tensile properties and compressive strength are measured according to ASTM D638 and D695, respectively. Compressive strength is measured to a deformation of 50% or to rupture, depending on which occurred first. Results are reported in Table 1. Resistance to solvent uptake is measured by immersing a specimen (tensile bar end of approximately similar size) in the specified solvent (water, hexanes, xylenes) for 24 hr and comparing the initial and post-immersion specimen weight after wiping excess solvent. Results are reported in Table 2.

### Comparative Example A

Comparative Example A is disclosed in US 20130310283 A1 as inventive examples 16 and 20. In this work, the physical properties of the thermosetting composition are evaluated in specimens that contain 62.5 weight percent sand of varying particle size, while in the present disclosure the physical properties of the neat thermosetting composition are disclosed. 35.1 g of PPG2000-diUA and 9.9 g grams TMPTA are combined via a SPEEDMIXER at 2500 rpm. 0.75 g AIBN (200 mg/mL in isopropanol) is added and the entire mixture combined using the SPEEDMIXER at 2500 rpm for 0.5 min. The mixture is then poured into a 0.55″ diameter×3″ height disposable plastic syringe or an aluminum mold pre-coated with a silicone release agent to form a rectangular plaque (4″×5″× 1/16″). The castings are allowed to cure at 100° C. overnight. Specimens for physical property evaluation are then prepared by using a saw to cut the cylindrical specimen to dimensions of 0.55″ diameter×1″ height or using a punch and compression device to prepare tensile specimens according to ASTM D638, Type 5.

Tensile properties and compressive strength are measured according to ASTM D638 and D695, respectively. Compressive strength is measured to a deformation of 50% or to rupture, depending on which occurred first. Results are reported in Table 1. Resistance to solvent uptake is measured by immersing a specimen (tensile bar end of approximately similar size) in the specified solvent (water, hexanes, xylenes) for 24 hr and comparing the initial and post-immersion specimen weight after wiping excess solvent. Results are reported in Table 2.

Cure kinetics are measured using a stress-controlled (1 Pa) ARES G2 rheometer using a cone (2°) and plate geometry (60 mm) or an ARES rheometer using a parallel plate geometry (25 mm). Viscosity is monitored as a function of time at constant temperature, strain rate, and frequency (1 Hz). Results are reported in Tables 3 to 5.

TABLE 1

| | | | Max. | | | | |
|---|---|---|---|---|---|---|---|
| | Max. | | Tensile | Tensile | | Strain at | Compressive |
| | Tensile | Max. | Stress | Young's | Max. | Max. | Young's |
| | Stress | Tensile | @ 100% | Modulus | Compressive | Compressive | Modulus |
| | (psi) | Strain (%) | (psi) | (psi) | Stress (psi) | Stress (%) | (psi) |
| Example | | | | | | | |
| 1 | 2310 | 260 | 1910 | 14,860 | 4,930 | 50 | 25,120 |
| 2 | — | — | — | — | 4,140 | 50 | 31,060 |
| 3 | — | — | — | — | 6,270 | 50 | 65,760 |
| 4 | — | — | — | — | 8,600 | 8* | 1,002,430 |
| 5 | 1740 | 140 | 1490 | 12,460 | 3,400 | 50 | 14,330 |
| Comp Ex | | | | | | | |
| A | 980 | 60 | — | 2,960 | 4,020 | 40^{†} | 18,290 |

*Sample yielded at specified strain and continued to deform to 50% strain.
^{†}Sample underwent brittle fracture at specified strain.

TABLE 2

| | % wt. gain | % wt. gain | % wt. gain |
|---|---|---|---|
| | (H₂O) | (hexanes) | (xylenes) |
| Example | | | |
| 1 | 30 | 1 | 45 |
| 2 | 2 | 1 | 65 |
| 3 | 6 | 0 | 47 |
| 4 | 18 | 0 | 10 |
| 5 | 57 | 2 | n.d. |
| Comp Ex | | | |
| A | 2 | 13 | dissolved |

TABLE 3

| | η (0 hr) | η (0.5 hr) | η (1 hr) | η (2 hr) | η (4 hr) | η (8 hr) | η (16 hr) |
|---|---|---|---|---|---|---|---|
| Example | | | | | | | |
| 1 | 1,520 | 2,400 | 4,040 | 13,750 | 309,500 | 3.44 × 10⁷ | 1.66 × 10⁸ |
| 2 | 790 | 2,590 | 28,170 | 220,000 | 1.40 × 10⁶ | 1.15 × 10⁷ | 1.70 × 10⁸ |
| 3 | 1,030 | 3,040 | 8,400 | 59,480 | 406,600 | 1.70 × 10⁷ | 1.99 × 10⁸ |
| Comp Ex | | | | | | | |
| A | 7,820 | 8,150 | 8,170 | 8,270 | 8,350 | 8,510 | 8,460 |

TABLE 4

| Example | η (0 hr) | η (0.5 hr) | η (1 hr) | η (2 hr) | η (4 hr) | η (8 hr) | η (16 hr) |
|---|---|---|---|---|---|---|---|
| 1 | 10,590 | 46,590 | 52,900 | 79,690 | 173,800 | 548,700 | 3.32 × 10⁶ |
| 4 | 30,400 | 48,250 | 62,700 | 103,000 | 291,800 | 4.01 × 10⁶ | 1.05 × 10⁸ |

TABLE 5

| | t_{cure} | t_{cure} | t_{cure} | t_{cure} | t_{cure} |
|---|---|---|---|---|---|
| | (10° C.) | (25° C.) | (45° C.) | (65° C.) | (75° C.) |
| Example | | | | | |
| 1 | 19 | 7 | 3 | 1 | n.d. |
| 2 | n.d. | 8 | 5 | 2 | n.d. |
| 4 | 9.2 | n.d. | n.d. | 0.6 | n.d. |
| Comp Ex | | | | | |
| A | — | >17^{†} | >16^{†} | 2 | 0.25 |

Cure time (t_{cure}) is defined as time (hr) to reach a viscosity of 10⁷ mPa · sec at constant temperature “^{†}” indicates no change in viscosity observed after specified time

What is claimed is:

1. A curable thermosetting composition useful as a drilling mud additive, said curable thermosetting composition comprising the reaction product of:
(i) a polyfunctional (meth)acrylate, a polyfunctional (meth)acrylamide, or mixture thereof,
(ii) one or more epoxy resin, and
(iii) one or more (cyclo)aliphatic polyamine.

2. The curable thermosetting composition of claim 1 wherein:
(i) each polyfunctional (meth)acrylate or polyfunctional (meth)acrylamide independently has a molecular weight of from 200 to 10,000 g/mol,
(ii) the one or more epoxy resin has a viscosity equal to or less than 50,000, and
(iii) the one or more (cyclo)aliphatic polyamine has a viscosity equal to or less than 50,000 cP.

3. The curable thermosetting composition of claim 1 wherein:
(i) the (meth)acryl polymer comprises one or more monomeric sub unit of ethylene glycol diethylene glycol, 1,3 butane diol, 1,4 butane diol, trimethylolpropane, ditrimethylolpropane, bisphenol-A diglycidyl ether diacrylate, dipentaerythritol pentaacrylate, poly(ethylene oxide), or poly(propylene oxide),
(ii) the epoxy resin comprises one or more monomeric sub unit of phenol, diglycidyl ether of bisphenol-A, diglycidyl ether of bisphenol-F, diglycidyl ether of bisphenol-S, diglycidyl ether of dicyclopentadiene, 3,4-epoxycyclohexylmethyl, or diglycidyl ethers of cyclohexanedimethanol, and
(iii) the (cyclo)aliphatic polyamine is amino ethyl piperazine or isophorondiamine.

4. The curable thermosetting composition of claim 1 useful as an additive for enhanced oil recovery (EOR); loss circulation material (LCM); wellbore (WB) strengthening treatments; soil stabilization; as a dust suppressant; as a water retainer; a soil conditioner; as a concrete or cement stabilizer; or as a sealer for any porous substrate.

5. A method to introduce a drilling mud comprising a curable thermosetting composition into a wellbore through a drill string, wherein the curable thermosetting composition comprises the reaction product of:
(i) a polyfunctional (meth)acrylate, a polyfunctional (meth)acrylamide, or mixture thereof,
(ii) one or more epoxy resin, and
(iii) one or more (cyclo)aliphatic polyamine.

6. The method of claim 5 wherein:
(i) the (meth)acryl polymer comprises one or more monomeric sub unit of ethylene glycol diethylene glycol, 1,3 butane diol, 1,4 butane diol, trimethylolpropane, ditrimethylolpropane, bisphenol-A diglycidyl ether diacrylate, dipentaerythritol pentaacrylate, poly(ethylene oxide), or poly(propylene oxide),
(ii) the epoxy resin comprises one or more monomeric sub unit of phenol, diglycidyl ether of bisphenol-A, diglycidyl ether of bisphenol-F, diglycidyl ether of bisphenol-S, diglycidyl ether of dicyclopentadiene, 3,4-epoxycyclohexylmethyl, or diglycidyl ethers of cyclohexanedimethanol, and
(iii) the (cyclo)aliphatic polyamine is amino ethyl piperazine or isophorondiamine.
